(19) United States
(12) Patent Application Publication
(10) Pub. No.: US 2009/0019223 A1
(43) Pub. Date: Jan. 15, 2009

(54) METHOD AND SYSTEMS FOR PROVIDING REMOTE STRAGE VIA A REMOVABLE MEMORY DEVICE

(76) Inventors: David B. Lection, Raleigh, NC (US); Robert P. Morris, Raleigh, NC (US)

Correspondence Address: SCENERA RESEARCH, LLC, 111 CORNING RD., SUITE 220, CARY, NC, 27518, US

(21) Appl. No.: 11/774,989

(22) Filed: Jul. 9, 2007

(51) Int. Cl. G06F 12/00

(52) U.S. Cl. 711/115; 711/E12.005

(57) ABSTRACT

A method and systems are described for providing remote storage via a removable memory device. The method includes intercepting a file write operation associated with storing a first file to the device and a file read operation associated with retrieving a second file from the device. In response to intercepting the write operation, contacting a server based on information included on the device to identify a storage location, storing a representation of the file on the device including an identifier for identifying the storage location, and providing for sending data provided by the write operation to the server for storage at the identified storage location. The method includes, in response to intercepting the file read operation, extracting an identifier for identifying a storage location on a server from a representation of the file stored on the device and providing for retrieving data from the identified storage location on the server.

### BACKGROUND

Today's computer users are storing more and more files. For example, a user may have multiple documents, image files, video files, audio files, and other files. Using today's systems, a user can store the files locally on a hard drive or a removable memory device. Alternatively, a user can purchase remote storage and use an Internet site to store the user's files.

As a user's file requirements increase, both in the number of unique files and in the size of the files (consider the size of high definition audio and video files), storing and transporting the files becomes more demanding. Meanwhile, physical limitations dictate that the amount of storage space in today's removable memory devices is limited.

Accordingly, there exists a need for methods, systems, and computer program products for providing remote storage via a removable memory device.

### SUMMARY

Methods and systems are described for providing remote storage via a removable memory device. According to an aspect, a method is described for providing remote storage via a removable memory device. The method includes intercepting a file write operation associated with storing a first file to a memory device and a file read operation associated with retrieving a second file from the memory device. The method includes, in response to intercepting the write operation, contacting a server based on information included on the memory device to identify a storage location, storing a representation of the file on the memory device including an identifier for identifying the storage location, and providing for sending data provided by the write operation to the server for storage at the identified storage location. The method also includes, in response to the intercepting of the file read operation, extracting an identifier for identifying a storage location on a server from a representation of the file stored on the memory device and providing for retrieving data from the identified storage location on the server.

According to another aspect, a system for providing remote storage via a removable memory device is described. The system includes means for intercepting at least one of a file write operation associated with storing a first file to a removable memory device and a file read operation associated with retrieving a second file from the removable memory device. The system also includes means for, in response to the intercepting of the file write operation, contacting a server based on information included on the removable memory device to identify a storage location on the server for storing data provided by the write operation, storing a representation of the first file on the removable memory device including an identifier for identifying the storage location, and providing for sending the data provided by the write operation to the server for storage at the identified storage location. The system further includes means for in response to the intercepting of the file read operation associated with retrieving a second file using the removable memory device, extracting an identifier for identifying a storage location on a server from a representation of the second file stored on the memory device and providing for retrieving data associated with the second file from the identified storage location on the server.

According to another aspect, a system for providing remote storage via a removable memory device is described. The system includes an operation router component configured for intercepting at least one of a file write operation associated with storing a first file to a removable memory device and a file read operation associated with retrieving a second file from the removable memory device. The system also includes a descriptor database manager component configured for in response to the intercepting of the file write operation, contacting a server based on information included on the removable memory device to identify a storage location on the server for storing data provided by the write operation, storing a representation of the first file on the removable memory device including an identifier for identifying the storage location, and providing for sending the data provided by the write operation to the server for storage at the identified storage location. The descriptor database manager component is further configured for in response to the intercepting of the file read operation associated with retrieving a second file using the removable memory device, extracting an identifier for identifying a storage location on a server from a representation of the second file stored on the removable memory device and providing for retrieving data associated with the second file from the identified storage location on the server.

According to another aspect, a computer readable medium including a computer program, executable by a machine, for providing remote storage via a removable memory device is described. The computer program includes executable instructions for intercepting at least one of a file write operation associated with storing a first file to a removable memory device and a file read operation associated with retrieving a second file from the removable memory device. The computer program also includes executable instructions for in response to the intercepting of the file write operation, contacting a server based on information included on the removable memory device to identify a storage location on the server for storing data provided by the write operation, storing a representation of the first file on the removable memory device including an identifier for identifying the storage location, and providing for sending the data provided by the write operation to the server for storage at the identified storage location. The computer program also includes executable instructions for in response to the intercepting of the file read operation, extracting an identifier for identifying a storage location on a server from a representation of the second file stored on the removable memory device and providing for retrieving data associated with the second file from the identified storage location on the server.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing remote storage via a removable memory device according to an embodiment of the subject matter described herein;

FIG. 2 is a block diagram illustrating a system for providing remote storage via a removable memory device according to another embodiment of the subject matter described herein;

FIG. 3 is a block diagram illustrating a system for providing remote storage via a removable memory device according to another embodiment of the subject matter described herein;

FIG. 4 is a block diagram illustrating a system for providing remote storage via a removable memory device according to another embodiment of the subject matter described herein; and

FIG. 5 is a block diagram illustrating a system for providing remote storage via a removable memory device according to another embodiment of the subject matter described herein.

### DETAILED DESCRIPTION

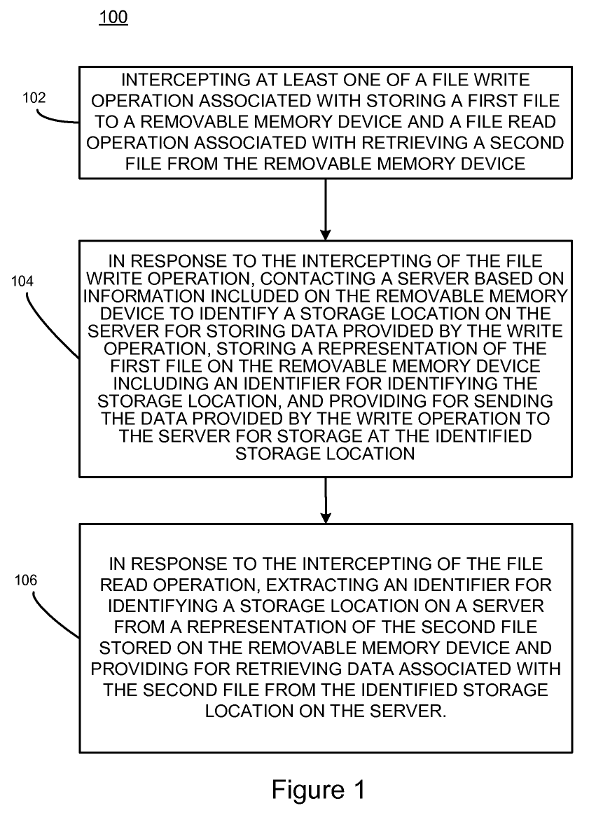

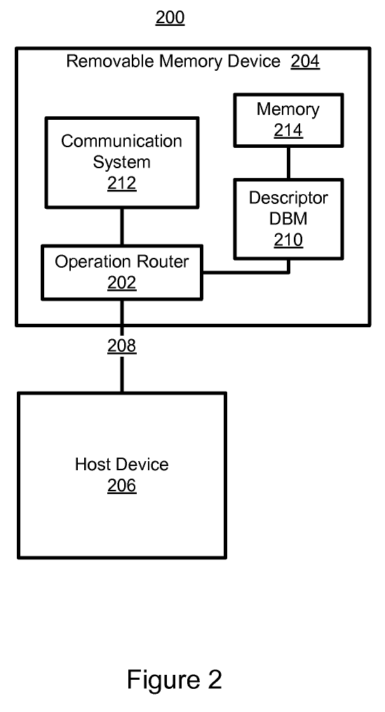

FIG. 1 is a flow diagram illustrating a method for providing remote storage via a removable memory device according to an exemplary embodiment of the subject matter described herein. FIG. 2 is a block diagram illustrating a system for providing remote storage via a removable memory device according to another exemplary embodiment of the subject matter described herein. The method illustrated in FIG. 1 can be carried out by, for example, some or all of the components illustrated in the exemplary system of FIG. 2.

With reference to FIG. 1, in block 102 at least one of a file write operation associated with storing a first file to the removable memory device and a file read operation associated with retrieving a second file from the removable memory device is intercepted. Accordingly, a system for providing remote storage via a removable memory device includes means for intercepting at least one of a file write operation associated with storing a first file to the removable memory device and a file read operation associated with retrieving a second file from the removable memory device. For example, as illustrated in FIG. 2, an operation router component 202 configured for intercepting at least one of a file write operation associated with storing a first file to a removable memory device and a file read operation associated with retrieving a second file from the removable memory device is included.

In FIG. 2, the removable memory device 204 can be operatively coupled to a host device 206, where the removable memory device 204 can communicate with the host device 206 via a communication link 208. In an aspect, the removable memory device 204 can be a Universal Serial Bus (USB)-compatible device. When the removable memory device 204 is a USB-compatible device, data read and/or write operations directed to the removable memory device 204 can be communicated via the communication link 208 supported by a USB-compatible interface. Alternatively, the communication link 208 can include a Personal Computer Memory Card International Association (PCMCIA) interface, a serial interface, a parallel port interface, an infrared link, or any other suitable communication link. A read operation or a write operation received via the communication link 208 is intercepted by the operation router component 202.

Both the host device 206 and the removable memory device 204 can include an operating environment configured to provide resources and services required by the components of the system 200 in performing the method 100. For example, both devices can include a processor memory for storing data and machine code instructions of an executable and a processor or controller configured to access the processor memory and perform the machine code instructions of the executable in processor memory and operating on data stored in the processor memory. Further, each device can include a control program, such as an operating system, for providing access to and managing resources included in each operating environment. An executable component can include an instruction for operating on a file.

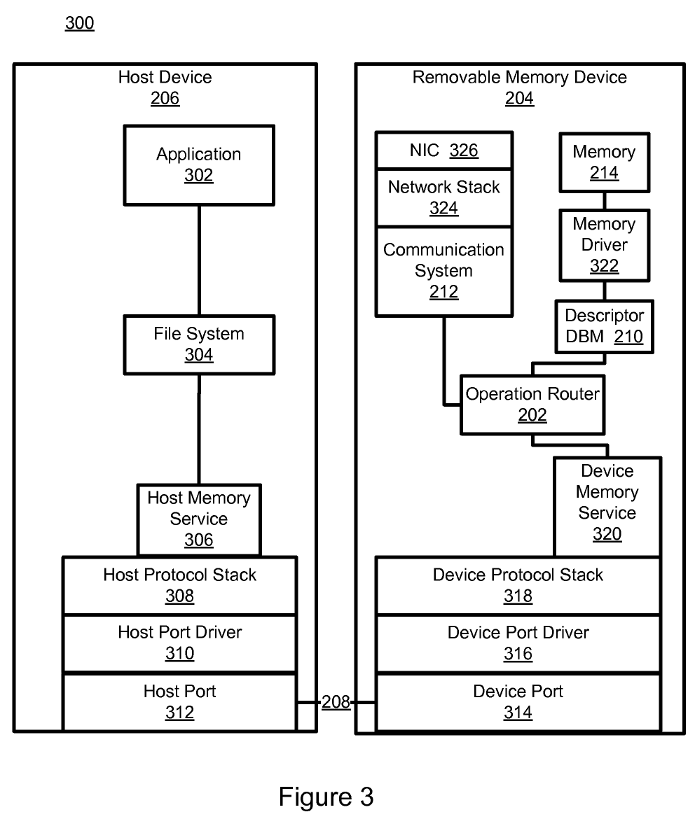

The system 300 illustrated in FIG. 3 provides a more detailed depiction of an aspect of the system 200 including additional components. The host device 206 can be configured to process an application 302. The application 302 can include instructions for reading a file, writing a file; creating a file, and deleting a file. In the illustrated example, the application 302 includes instructions for invoking one or more functions of a file system 304 included in the operating environment of the host device 206. The file system can be configured to use a driver of an input/output (I/O) subsystem (not shown) of the operating environment of the host device 206 to perform file system functions invoked by the application 302. The I/O subsystem can support drivers for a hard drive included in the host device 206, drivers for network attached storage using a communication subsystem of the operating environment, and drivers for supporting removable storage devices connected by the communication link 208 for communicating with a peripheral device such as the removable memory device 204. Systems that are transparent to a file system can be referred to as I/O-based systems. Alternatively, a file system can be configured to provide a host interface and a service that passes file system commands to the removable memory device 204 for processing. Systems that pass file system commands to the removable memory device 204 while bypassing the I/O subsystem of the host device 206 can be referred to as file system based systems.

In FIG. 3, the host device 206 can communicate with devices supporting multiple functional categories of services such as media capture and/or network communications. Those devices can be operatively coupled to the host device 206 via the communication link 208. Each functional category of services can be associated with a host service component for sending messages via the communication link 208 for performing functions of the corresponding service. For storage/memory functionality, the host device 206 in FIG. 3 can include a host memory service 306. In I/O-based systems, the file system 304 can communicate with the host memory service 306 to perform basic I/O operations for carrying out file system functions, such as operations associated with a file in association with the removable storage device 202. In file system based systems, the file system 304 can communicate with the host memory service 306 to perform file system level operations associated with a file in association with the removable storage device 202.

A communication protocol stack, such as a host protocol stack 308 can be provided corresponding to the type of link 208 and the protocol required for allowing communication between the services supported between the host device 206 and the removable memory device 204. A host protocol can be converted to signals that can be sent via the link 208 using a media access control layer (often a hardware adapter and software driver), depicted as a host port driver 310 and a host port 312, for generating and receiving signals via the link 208 to which the host port 312 hardware is operatively coupled. Thus, a read operation and/or a write operation can be sent from the file system 304 directed to the removable memory device 204 using a communication protocol to communicate the read and/or the write operation over the link 208 to the removable memory device 204.

As described above in an aspect, the removable memory device 204 can be a USB-compatible device. In an I/O-based system the host memory service 306 can support the USB mass storage device class for the host device 206. The USB mass storage device class (USB MSC) is a set of computing communications protocols defined by the USB Implementers Forum that operate via the Universal Serial Bus. The standard provides an interface to a variety of storage devices. The USB mass storage specification does not require any particular file system to be used by conforming devices. Instead, it provides a simple interface to read and write sectors of data (much like the low-level interface used to access any hard drive) using, for example, the Small Computer System Interface (SCSI) transparent command set. Operating systems can treat the USB drive like a hard drive, and can format it with any file system.

In a file system based system, the host memory service 306 can support a file system service class that passes file system level commands from the host device 206 to the removable memory device 204 for processing. In the USB-based environment, the host protocol stack 308 can be a USB host protocol stack, and the host port driver 310 can be a USB host controller driver, and the host port 312 can be a USB host controller compatible with the communication link 208.

Read operation information and write operation information, represented as signals, can be transmitted from the host device 206 to the removable memory device 204 via the link 208. The signals can be received by a communication stack in the removable memory device 204. For example, FIG. 3 illustrates a device port 314 and a device port driver 316 corresponding to the host port 312 and host port driver 310; and a device protocol stack 318 corresponding with the host protocol stack 308. In the exemplary USB-based system, the device protocol stack 318, the device port driver 316, and the device port 314 can conform to the specifications of USB. Analogously, a device memory service 320 compatible with the host memory service 306 is included in the removable memory device 204 for communicating with the host memory service 306 via the device port 314, the device port driver 316, the device protocol stack 318, and the communication link 208. File system 304 read and/or write operations are received by the removable memory device 204 via the communication components described above. In FIG. 3, when the removable memory device 204 receives either read operation information or write operation information, the operation information is intercepted by the operation router component 202 for processing.

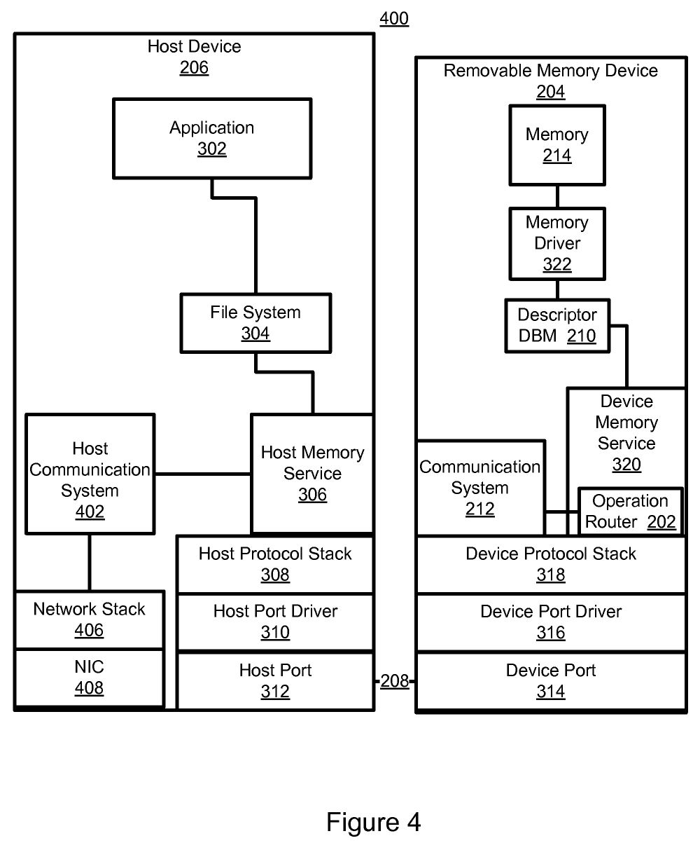

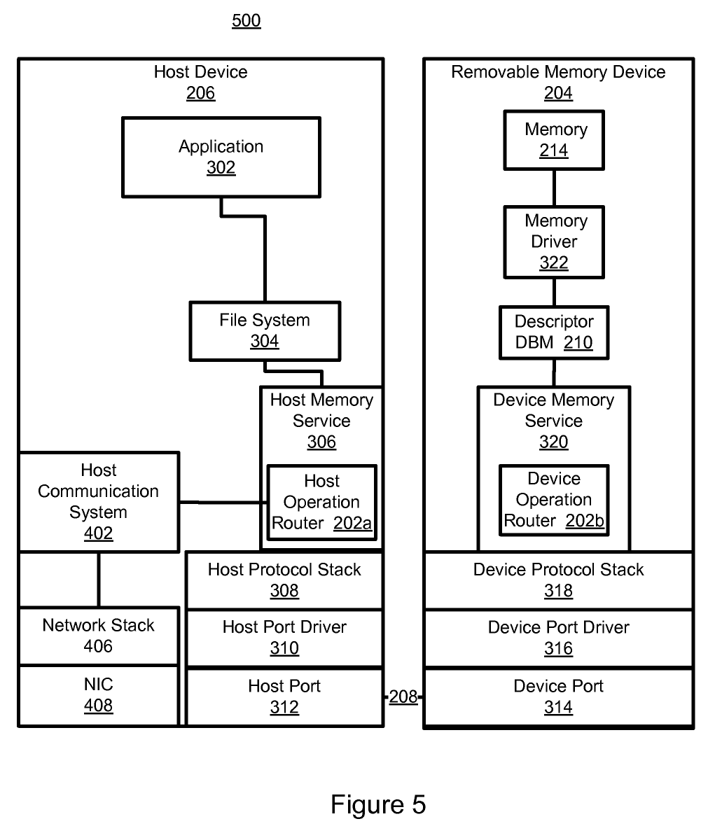

FIGS. 4 and 5 illustrate a system 400 and a system 500 respectively. The systems 400 and 500 illustrate alternative systems for performing the method 100. In FIG. 4, the operation router component 202 is included in the device memory service 320, rather than being separate. The operation of the system 400 is analogous to the operation of the system 300 with respect to performing block 102 of the method 100. In FIG. 5, an operation router component 202a is included in the host memory service 306 included in the host device 206. Thus, block 102 is performed in the system 500 when the operation router component 202a intercepts read operation information or write operation information from the host memory service 306 before the operation information is transmitted to the removable memory device 204 from the host device 206. The application 302 and the file system 304 operate as described above. In the example illustrated in FIG. 5, the read and write operation information need not be transmitted to the removable memory device 204. Rather, the operations are intercepted by the operation router component 202a included in the host memory service 306 included in the host device 206.

Returning to FIG. 1, in block 104, in response to the intercepting of the file write operation, a server is contacted based on information included on the removable memory device to identify a storage location on the server for storing data provided by the write operation, a representation of the first file is stored on the removable memory device including an identifier for identifying the storage location, and sending the data provided by the write operation to the server for storage at the identified storage location is provided for. Accordingly, a system for providing remote storage via a removable memory device includes means for, in response to the intercepting of the file write operation, contacting a server based on information included on the removable memory device to identify a storage location on the server for storing data provided by the write operation. The means further for storing a representation of the first file on the removable memory device including an identifier for identifying the storage location, and for providing for sending the data provided by the write operation to the server for storage at the identified storage location. For example, as illustrated in FIG. 2, a descriptor database manager component (DBM) 210 is configured for, in response to the intercepting of the file write operation, contacting a server based on information included on the removable memory device to identify a storage location on the server for storing data provided by the write operation. The descriptor database manager component 210 further configured for storing a representation of the first file on the removable memory device including an identifier for identifying the storage location, and for providing for sending the data provided by the write operation to the server for storage at the identified storage location.

As discussed above, the operation router component 202 is configured to intercept a write operation associated with a first file where the write operation is directed to the removable memory device 204. In response to the interception of the write operation, the descriptor database manager component 210 is configured to identify a storage location on the server for storing data provided by the write operation based on information included on the removable memory device 204. Further, the descriptor database manager component 210 is configured for storing a representation of the first file on the removable memory device 204 including an identifier for identifying the storage location. The descriptor database manager component 210 is configured to provide for sending the data provided by the write operation to the server for storage at the identified storage location.

In FIG. 2, when the operation router component 202 intercepts operation information associated with a write operation, the operation router component 202 calls the descriptor database manager component 210 to determine a storage location on a server for storing data provided by the write operation based on information included on the removable memory device 204. For example, the information included on the removable memory device 204 can include a full or partial path name or a uniform resource identifier (URI), such as a “file://” URL, for identifying the remote server.

In an exemplary I/O-based system type, the descriptor database manager component 210 can maintain directory information compatible with the file system used by the host device 206. For example, the device can support a File Application Table (FAT) interface, an Encrypting File System (EFS) interface, Windows® NT File System (NTFS) or any other file system storage format. In traditional I/O-based file systems, files are normally stored in, for example, sectors for FAT on disk file systems. The I/O-based system described above provides an appearance that it operates the same way.

According to an aspect, files can be stored in a virtual FAT, EFS, NTFS, or host compatible file system storage format where the storage format can be emulated on a remote storage device using a file system on a removable storage device. That is, the descriptor database manager 210 can be configured to determine a physical storage address, such as a sector number and offset, for identifying a storage location on a remote storage device. The identifier including the sector number and offset can be translated to an offset into a file on a server where portions of the file are mapped to corresponding portions of the supported storage format of the removable media device 204.

In another aspect, the identifier including the sector number and offset can identify a physical storage address of a storage location a physical storage media provided by the remote storage device. The format of the physical storage media can be compatible with the identifier provided by the descriptor database manager 210. In a file system based system, the descriptor database manager 210 can be configured to determine a file system level address such as a file path, file name or other identifier and an offset or record in the file. The file system level identifier can be translated to a corresponding file system level identifier of a file on a server. In an aspect, the identifier provided by the descriptor database manager 210 and the identifier of the remote storage device can be the same. In another aspect, a mapping can be performed from an identifier space of the removable memory device 204 and an identifier space of the remote storage device and vice versa. When location information is included in an intercepted write operation, the location information can be used in determining an identifier of a storage location on the remote server for storing data provided by the write operation. The storage location is determined by the removable memory device 204 along, or in cooperation, with the remote storage device according to an aspect of the system, irrespective of whether the system is an I/O-based system or a file system based system.

Additional information from the storage file system format can be stored in the memory 214 included in the removable memory device 204. Examples of additional information can include file metadata, such as file size, times associated with creation and last update, security permissions and owner information, one or more visual representations associated with a file, and type information such as a MIME type indicator. According to an aspect, in an I/O-based system, the descriptor database manager component 210 can be configured to manage a remote physical storage area tracking used and available physical storage; and allocating and freeing physical storage as needed while updating the directory table(s) accordingly. According to another aspect, the descriptor database manager component 210 can be configured to maintain a cache of the directory table(s) corresponding to physical storage where the directory tables and storage allocation is managed by the server.

As described above, according to an aspect, the descriptor database manager component 210 need not require interoperation with the server including the identified storage location in order to determine the storage location based on information included on the removable memory device 204. For example, the descriptor database manager component 210 can include a file path or a URI in the information included on the removable memory device 204. The descriptor database manager component 210 can determine the storage location at the file level when the information included on the removable memory device 204, such as a path name or URI, identifies where the file associated with the write operation will be stored. The descriptor database manager component 210 can cooperate with the server by exchanging storage information via a communication system component 212 using a remote storage protocol. Examples of remote storage protocols include protocols for the Andrew File System (AFS), the UNIX network file system (NFS), and the SaMBa network file system. An I/O-based system, for example, can use the Internet Small Computer System Interface (iSCSI) protocol providing physical level access over Transmission Control Protocol/Internet Protocol (TCP/IP) to manage a remote physical media at the I/O subsystem level. The exemplary protocols listed above do not provide an exhaustive list.

As described above, the descriptor database manager component 210 can identify the server, for example, using information included on the removable memory device 204 such as a network address of the server or a URI of the server. The information, for example, can be stored in the memory 214 of the removable memory device 204. For example, the information can be stored in one of flash RAM, or Read Only Memory (ROM) so that the memory address is persisted permanently. Alternatively, the server address can be loaded into the device memory 214 dynamically during device initialization. Additional information associated with the server can also be stored in device memory 214. The information can include authentication information for authenticating and authorizing the removable memory device 204 and information for authenticating and authorizing a server. According to an aspect, information identifying multiple servers can be included for storing files on multiple servers. A server can be determined for an operation based on user information stored in the memory 214 or on a server. The server can be determined based on the type of file indicated, for example, by a MIME type indicator where associations between a MIME type and a server can be stored in the memory 214 or on a server.

As described above, the descriptor database manager component 210 automatically creates a representation of the first file. The representation of the first file is stored in the memory 214 included in the removable memory device 204. The representation includes an identifier for identifying the storage location for the first file. The representation of the first file can include two components. First, the representation can include an identifier component for the first file for identifying storage locations on remote storage associated with data of the first file. The second component that can be included in the representation is a user-recognizable representation of the first file. The user-recognizable representation can include an iconic image representing the contents of the first file. The descriptor database manager component 210 can analyze the contents of the first file and generate or select the iconic image representing the contents of the first file. Alternatively, the user-recognizable representation can include an iconic image of the class of the first file, for example a “Document” class. For example, the descriptor database manager component 210 can analyze the first file to determine the class of file and select the iconic image representing the class of the first file. Alternatively, the user-recognizable representation can include a subset fragment of the data of the first file, for example, a short audio sequence that represents the contents of an audio file. The descriptor database manager component 210 can analyze the contents of the audio file and extract a short audio sequence from the content of the audio file for representing the contents of the first file. According to an aspect, the two components of the representation can be stored together in a single file. For example, an icon file can contain a metadata area that associates the icon with a particular file. Thus, both the identifier and the user-recognizable representation are stored in the icon file. Alternatively, the components can be stored in separate locations but with an association mechanism, e.g. database, that maintains the relationship between the identifier and the user representation of the file.

A representation can include any other metadata associated with the file such as a thumbnail, a description, a keyword, and a hash value, for example. According to an aspect, the identifier for identifying the storage location can include at least one of a uniform resource identifier and a network address. If a file identifier does not exist for the first file associated with the write operation intercepted by the operation router component 202, an identifier is created by the descriptor database manager component 210 and stored in the memory 214 of the removable storage device 204 as a portion of the representation of the first file. For example, in response to a file create request from the application 302 to the file system 304, an identifier can be created by the descriptor database manager component 210. For purposes of this description, a create operation is considered a type of write operation. If an identifier already exists, the identifier can be updated according to the metadata associated with the file. In an I/O-based system where the descriptor database manager component 210 manages a physical storage area of a server by tracking and allocating free and used physical storage locations, the directory information in the memory 214 can be updated by the descriptor database manager component 210 to mark the location as used when a free storage location is determined to be the location where the data associated with the write operation is to be stored. A write operation that overwrites existing data can require locating free physical storage and marking it as used or freeing previously used physical storage and marking it free depending on the sizes of the old and new data associated with the determined location.

As described above, the descriptor database manager component 210 provides for sending the data provided by the write operation to the server for storage at the identified storage location. In an aspect, providing for sending the data provided by the write operation to the server for storage at the identified storage location includes sending the data provided by the write operation via a communication system 212 of the removable memory device 204 to the server for storage at the identified storage location. For example, the removable memory device 204 includes a communication system component 212 configured for sending the data provided by the write operation to the server for storage at the identified storage location.

For example, the communication system component 212 can establish a connection with the server. The communication system component 212, based on an intercepted write operation, receives data for storage and the determined storage location. The storage location can be a location in a virtual storage media such as a virtual disk or a location on a physical storage media. The communication system component 212 can generate a message based on the remote storage protocol used including the operation information providing the data to be written, the first file identifier, and additional storage location information as described above. The communication system component 212 sends the message including the data via a network (not shown) to the server for storing the data provided by the write operation on the server at the identified location.

Referring again to FIG. 3, the system 300 includes the operation router component 202 configured to receive operation information associated with a write operation and calls the descriptor database manager component 210 to determine an identifier for identifying a storage location on a remote server for storing data provided by the write operation, as described above. In FIG. 3, the descriptor database manager component 210 can access the memory 214 using an I/O driver, depicted as a memory driver 322. For example, the memory driver 322 can be a SCSI driver, an IDE driver, or any of the numerous driver types available for accessing physical storage. Note the driver type can depend on the memory technology used by the memory 214. In file system based systems, the descriptor database manager component 210 is configured to provide a file system component compatible with memory driver 322 allowing the descriptor database manager component 210 to maintain representations of directories and files in the memory 214 from the perspective of the descriptor database manager component 210. In I/O-based systems, the descriptor database manager component 210 can be configured to interoperate with the memory driver 322 to access the directory information of the file system storage format used, thus accessing file representations at the file system storage format level.

To provide communications, the removable memory device 204 can include a network stack 324 for providing a network protocol for transporting messages conforming to the protocol of the communication system component 212. For example, when the communication system component 212 supports the iSCSI storage protocol or the SaMBa protocol, the network stack 324 can be a TCP/IP stack. A network interface card (NIC) 326 operatively coupled to the network stack 324 can be included in the removable memory device 204 for allowing a connection to a network media, such as a coaxial cable, a Cat 5 cable, or a wireless media. The MAC layer can support, for example, Ethernet over coax, Ethernet over Cat 5 cable, WiMax, an 802.11 protocol, an 802.22 protocol, or a Code Division Multiple Access (CDMA) variant.

Referring again to FIG. 4, the removable memory device 204 uses the network capabilities of the host device 206 to interoperate with the server for performing the write operation. As described above, the removable memory device 204 can be operatively coupled to the host device 206. According to an aspect, when the removable memory device 204 is operatively coupled to the host device 206, providing for sending the data provided by the write operation to the server can include sending the data provided by the write operation to the communication system component 402 of the host device 206. The communication system 402 of the host device 206 is configured for sending the data provided by the write operation to the server for storage at the identified storage location. Thus, the removable memory device 204 can send the data provided by the write operation to the server for storage via the communication system 402 of the host device 206.

The operation router component 202 can provide operation information to the communication system 402 of the host device 206. Further, additional information associated with the write operation, server information returned by the descriptor database manager component 210 described above, and storage location information determined as described above can also be provided. The host communication system 402 can provide extensions to the services of the host memory service 306 for the removable memory device 204. Specifically, the host communication system 402 can provide access to remote storage. The host communication system 402 and the removable memory device 204 communication system 212 can communicate using the host protocol stack 308 and the device protocol stack 318, the host port driver 310 and the device port driver 316, the host port 312 and the device port 314, and the communication link 208 to communicate in a manner analogous to that described above for the host memory service 306 and the device memory service 320. A host communication system 402 and a device communication system 212 pair can support any of the file level or physical memory level protocols the system 300 supports. The host communication system 402 and device communication system 212 pair can provide a communication path between the operation router component 202 and the host communication system component 402 operating in the host operating environment using a host-provided network stack 406, a physical layer provided by a network interface card (NIC) 408 such as an Ethernet adapter or an 802.11 wireless network adapter.

Referring again to FIG. 5, providing for sending the data provided by the write operation to the server can be split between the host device 206 and the removable memory device 204 by including a host operation router component 202a in the host memory service component 306 and including a device operation router component 202b in the device memory service component 320. The host operation router component 202b and device operation router component 202b pair can communicate using an extension of the memory service protocol provided by the host memory service 306 and device memory service 320, as described above. Additionally the communication system component 402 is included in the host device 206 and interoperates with the host operation router component 202a as the communication system component 212 interoperates with the operation router component 202. Thus, interoperation of the device operation router component 202b with the descriptor database manager component 210 is analogous to the interoperation described in FIG. 3 between the operation router component 202 and descriptor database manager component 210, and the interoperation of the host operation router component 202a with the remote storage protocol 212 is analogous with the corresponding operation described in FIG. 3.

In another aspect, in response to intercepting a file write operation for storing data provided by the write operation, it is determined whether the data can be stored according to predefined storage size information included on the removable memory device 204. For example, the operation router component 202 can be configured for determining whether the data can be stored according to predefined storage size information included on the removable memory device 204. In example, the amount of server storage a user has purchased can be stored on the removable memory device 204. The operation router component 202 can be configured to keep track of the amount of storage used on the server, and can be configured to prevent a write operation from storing data provided by the write operation when the server file space is exhausted.

In another aspect, providing for sending data provided by a write operation to the remote storage server for storage at the identified storage location can include storing the data on the removable memory device 204 and scheduling the sending of the data provided by the write operation for sending the data via a network to the server at a later time. For example, the descriptor database manager component 210 can be configured to store data provided by a write operation in the memory 214 included in the removable memory device 204 and for scheduling the sending of the data provided by the write operation for sending the data via a network to the server at a later time. The removable memory device 204 can include a battery (not shown) and a communication system 212 as illustrated in FIG. 3 and described above. The battery can be rechargeable and/or replaceable. The battery can provide power for the operation of the removable memory device 204 when the removable memory device 204 is not connected to a host device. The battery power allows the removable memory device 204 to continue to send data that has been queued to a server. According to an aspect, in case the power is too low for performing storage operations via the communication system, the device can also queue data provided by a write operation in the memory 214. When the device is either subsequently coupled to a host device or its battery is replaced or recharged, the processing of the queued data for storage can be restarted. Analogously, a retrieval of the data can be scheduled for retrieving the data via a network from the server at a later time. For example, the descriptor database manager component 210 is configured for scheduling the retreival of the data associated with the second file for retreiving the data via a network from the server at a later time.

In block 106 of the method 100, in response to the intercepting of the file read operation, an identifier for identifying a storage location on a server is extracted from a representation of the second file stored on the removable memory device and the retrieving of data associated with the second file from the storage location on the server identified by the extracted identifier is provided for. Accordingly a system for providing remote storage via a removable memory device include means for, in response to intercepting a read operation associated with a file directed to the removable memory device, extracting an identifier for identifying a storage location on a server from a representation of the file stored on the removable memory device and for providing for retrieving data identified by the read operation from the identified storage location on the server. For example, as illustrated in FIG. 2, the descriptor database manager component 210 is configured for, in response to the intercepting of the file read operation, extracting an identifier for identifying a storage location on a server from a representation of the second file stored on the removable memory device and providing for retrieving data associated with the second file from the identified storage location on the server.

In FIG. 2, when the operation router component 202 intercepts operation information associated with a read operation for a second file, the operation router component 202 responds by calling the descriptor database manager component 210 to extract an identifier from a representation stored in the memory 214 of the removable memory device 204 for locating a storage location on a remote server storing data associated with the second file. For example, the read operation can include information identifying the second file and a location within the second file for reading. The descriptor database manager component 210 uses the information identifying the second file to locate a representation of the second file stored in the memory 214 of the removable memory device 204. A representation of the second file includes an identifier for identifying the storage location of the second file. The identifier is extracted from the representation for use in retrieving data associated with the second file from the storage location based on the location information, if any, provided by the read operation. If a file identifier does not exist for the second file associated with a read operation received by the operation router component 202, an error indication can be returned via the communication link 208 to the host device 206 for processing in an aspect. Alternatively, the removable memory device 204 can communicate with a server according to an identifier of the server stored in the memory 214, discussed above. The communication can include the identifier provided by the read request. When a response is received from the remote server including information associated with a file located with the identifier, a representation of the second file can be stored in the memory 214 of the removable memory device.

The descriptor database manager component 210, in an aspect, can identify the server using an identifier extracted from a representation of a file stored in the memory 214. According to another aspect, a network address of the server or a URI of the server can be stored in the memory 214 as described above.

According to an aspect, providing for retrieving data associated with the second file from the storage location on the server identified based on the extracted identifier includes retrieving data associated with the second file from the storage location on the server identified based on the extracted identifier via a communication system of the removable memory device 204. For example, the removable memory device 204 includes the communication system 212 that is configured for retrieving data associated with the second file from the storage location on the server identified based on the extracted identifier. In an example, the descriptor database manager component 210 can return the server information and the identifier for identifying the storage location to the operation router component 202 for interoperating with the server to perform the file read operation for the second file. In the case where control is returned to the operation router component 202, the operation router component 202 invokes the communication system component 212 using an interface compatible with the protocol used to communicate with the server to retrieve the second file. Alternatively, the descriptor database manager component 210 performs this function via the communication system component 212.

For example, the communication system component 212 can establish a connection with the server. The communication system component 212, based on the intercepted read operation, receives an identifier for identifying the storage location where the data to be read is stored. The storage location can be a location in a virtual storage media such as a virtual disk or a location on a physical storage media. The operation router component 202, in an example, can send a read operation to the communication system component 212 along with the retrieved identifier for identifying a storage location to be read. The communication system component 212 generates a message based on the protocol supported by the server where the message includes operation information, and the extracted identifier and/or an identifier based on the extracted identifier of the storage location as determined by the descriptor database manager component 210. The communication system component 212 sends the message via a network (not shown) to the server to retrieve the data stored at the location identified based on the identifier. The server returns the data in a response message to the communication system component 212. The data received by the communication system component 212 in the response message can be sent to the host device 206 by the communication system component 212 invoking the operation router component 202. The operation router component 202 returns the read data via the link 208 to the host device 206. In another aspect, a copy of the retrieved data is stored on the removable memory device 204, where the data from the second file can be retrieved from the removable memory device 204. For example, the descriptor database manager component 210 can be configured for storing a copy of the retrieved data from second file in the memory 214 included in the removable memory device 204, where the data can be retrieved from the removable memory device 204.

Referring again to FIG. 3, the system 300 includes the operation router component 202 configured to receive operation information associated with the file read operation and calls the descriptor database manager component 210 to extract an identifier from a representation of the second file. The identifier for identifying a storage location on a remote server where data of the second file is stored. In FIG. 3, the descriptor database manager component 210 can access the memory 214 using an I/O driver, depicted as a memory driver 322. For example, the memory driver 322 can be a SCSI driver, an IDE driver, or any of the numerous driver types available for accessing physical storage. Note the driver type can depend on the memory technology used by the memory 214. In file system based systems, the descriptor database manager component 210 is configured to provide a file system component compatible with the memory driver 322 for allowing the descriptor database manager component 210 to maintain representations of directories and files in the memory 214 from the perspective of the descriptor database manager component 210. In I/O-based systems, the descriptor database manager component 210 can be configured to interoperate with the memory driver 322 to access the directory information of the file system storage format used, thus accessing file representations at the file system storage format level.

To provide communications, the removable memory device 204 can include a network stack 324 for providing a network protocol for transporting messages conforming to the protocol of the communication system component 212. For example, when the communication system component 212 supports the ISCSI storage protocol or the SaMBa protocol, the network stack 324 can be a TCP/IP stack. A network interface card (NIC) 326 can be included in the removable memory device 204, where the NIC 326 is operatively coupled to the network stack 324 for enabling connection to a network media, such as a coaxial cable, a Cat 5 cable, or a wireless media. The NIC 326 can support, for example, Ethernet over coax, Ethernet over Cat 5 cable, WiMax, an 802.11 protocol, 802.22, or a CDMA variant.

In another aspect, the removable memory device 204 can be operatively coupled to the host device 206, where providing for retrieving data associated with the second file from the storage location on the server identified based on the extracted identifier includes sending the extracted identifier and/or an identifier based on the extracted identifier to a communication system of the host device 206, where the communication system of the host device 206 is configured for retrieving data associated with the second file from the identified storage location on the server. For example, when the removable memory device 204 is operatively coupled to a host device 206, where the descriptor database manager component 210 is configured for sending the identifier information to a communication system of the host device 206, the host device 206 communication system component can be configured for retrieving data associated with the second file from the storage location on the server based on the identifier information.

Referring again to FIG. 4, the removable memory device 204 interoperates with the server via the network capabilities of the host device 206 for performing the read operation. As described above, the removable memory device 204 can be operatively coupled to the host device 206. According to an aspect, when the removable memory device 204 is operatively coupled to the host device 206, providing for retrieving data associated with the second file from the server can include sending the identifier for identifying the storage location of the second file to the communication system component 402 of the host device 206. The communication system 402 of the host device 206 is configured for retrieving data associated with the second file from the server at the identified storage location. Thus, the removable memory device 204 can retrieve the second file from the server via the communication system 402 of the host device 206.

The operation router component 202 can provide operation information to the communication system 402 of the host device 206. Further, additional information associated with the read operation, server information returned by the descriptor database manager component 210 described above, and storage location information determined as described above can also be provided. The device communication system 402 can provide extensions to the services of the device memory service 320 for the removable memory device 204. Specifically, the device communication system 402 can provide access to remote storage. The host communication system 402 and device communication system 212 can communicate using the host communication stack 308 and the device communication stack 318, the host device 206 driver 310 and the removable memory device 204 port driver 316, the host device 206 port 312 and the device port 314, and the communication link 208 to communicate in a manner analogous to that described above for the host memory service 306 and the device memory service 320 to communicate. A host communication system 402 and a device communication system 212 pair can support any of the file level or physical memory level protocols that the system 300 supports. The host communication system 402 and device communication system 212 pair can provide a communication path between the operation router component 202 and the host communication system component 402 operating in the host operating environment using a host-provided network stack 406 and/or a physical layer provided by a network interface card (NIC) 408 such as an Ethernet adapter illustrated in FIG. 4 and in FIG. 5.

Referring again to FIG. 4, providing for retrieving data associated with the second file from the server can be split between the host device 206 and the removable memory device 204 by including a host operation router component 202a in the host memory service component 306 and including a device operation router component 202b in the device memory service component 320. The host operation router component 202b and device operation router component 202b pair can communicate using an extension of the memory service protocol provided by the host memory service 306 and device memory service 320, as described above. Additionally the communication system component 402 is included in the host device 206 and interoperates with the host operation router component 202a as the communication system component 212 of FIG. 3 interoperates with the operation router component 202 of the system FIG. 3. Thus, interoperation of the device operation router component 202b with the descriptor database manager component 210 is analogous to the interoperation as described in FIG. 3 between the operation router component 202 and descriptor database manager component 210, and the interoperation of the host operation router component 202a with the remote storage protocol 212 is analogous with the corresponding operation described for the system 300. The extracted identifier and/or an identifier based on the extracted identifier can be sent to either the host operation router component 202a in the host memory service component 306 or the device operation router component 202b in the device memory service component 320. Depending on whether the host device 206 is used or the removable memory device 204 is used, each operation router invokes its respective communication system (communication system 212 or host communication system 402) to retrieve data identified by an intercepted read operation from the identified storage location on the server.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing remote storage via a removable memory device, the method comprising:
intercepting at least one of a file write operation associated with storing a first file to a removable memory device and a file read operation associated with retrieving a second file from the removable memory device;
in response to the intercepting of the file write operation, contacting a server based on information included on the removable memory device to identify a storage location on the server for storing data provided by the write operation, storing a representation of the first file on the removable memory device including an identifier for identifying the storage location, and providing for sending the data provided by the write operation to the server for storage at the identified storage location; and
in response to the intercepting of the file read operation, extracting an identifier for identifying a storage location on a server from a representation of the second file stored on the removable memory device and providing for retrieving data associated with the second file from the identified storage location on the server.

2. The method of claim 1 including, in response to the intercepting of the file write operation associated with storing the data provided by the write operation, determining whether the data provided by the write operation can be stored at the identified storage location based on predefined storage size information included on the removable memory device.

3. The method of claim 1 wherein the removable memory device is operatively coupled to a host device and wherein providing for sending the data provided by the write operation to the server includes sending the data provided by the write operation to the server for storage at the identified storage location via a communication system of the host device.

4. The method of claim 1 wherein providing for sending data provided by the write operation to the server for storage at the identified storage location includes sending the data provided by the write operation via a communication system of the removable memory device to the server for storage at the identified storage location.

5. The method of claim 1 wherein the removable memory device is operatively coupled to a host device, and wherein providing for retrieving the data associated with the second file from the storage location on the server identified by the extracted identifier includes sending the identifier to a communication system of the host device for retrieving the data associated with the second file from the storage location on the server via the communication system of the host device.

6. The method of claim 1 wherein providing for retrieving the data associated with the second file from the storage location on the server identified by the extracted identifier includes retrieving the data associated with the second file from the storage location on the server identified by the extracted identifier via a communication system of the removable memory device.

7. The method of claim 6 including storing a copy of the retrieved the data associated with the second file on the removable memory device, wherein the the data associated with the second file can be retrieved from the removable memory device.

8. The method of claim 1 wherein providing for sending the data provided by the write operation to the server for storage at the identified storage location includes storing the data provided by the write operation on the removable memory device and scheduling the sending of the data provided by the write operation for sending the data via a network to the server at a later time.

9. The method of claim 1 wherein providing for retrieving data associated with the second file from the identified storage location on the server includes scheduling the retreival of the data associated with the second file for retreiving the data via a network from the server at a later time.

10. The method of claim 1 wherein the removable memory device is a universal serial bus compatible device.

11. The method of claim 1 wherein the identifier for identifying the storage location includes at least one of a uniform resource identifier and a network address.

12. A system for providing remote storage via a removable memory device, the system comprising:
means for intercepting at least one of a file write operation associated with storing a first file to a removable memory device and a file read operation associated with retrieving a second file from the removable memory device;
means for, in response to the intercepting of the file write operation, contacting a server based on information included on the removable memory device to identify a storage location on the server for storing data provided by the write operation, storing a representation of the first file on the removable memory device including an identifier for identifying the storage location, and providing for sending the data provided by the write operation to the server for storage at the identified storage location; and
means for in response to the intercepting of the file read operation associated with retrieving a second file using the removable memory device, extracting an identifier for identifying a storage location on a server from a representation of the second file stored on the memory device and providing for retrieving data associated with the second file from the identified storage location.

13. A system for providing remote storage via a removable memory device, the system comprising:
an operation router component configured for intercepting at least one of a file write operation associated with storing a first file to a removable memory device and a file read operation associated with retrieving a second file from the removable memory device;
a descriptor database manager component configured for in response to the intercepting of the file write operation, contacting a server based on information included on the removable memory device to identify a storage location on the server for storing data provided by the write operation, storing a representation of the first file on the removable memory device including an identifier for identifying the storage location, and providing for sending the data provided by the write operation to the server for storage at the identified storage location; and
the descriptor database manager component further configured for, in response to the intercepting of the file read operation associated with retrieving a second file using the removable memory device, extracting an identifier for identifying a storage location on a server from a representation of the second file stored on the removable memory device and providing for retrieving data associated with the second file from the identified storage location on the server.

14. The system of claim 13 wherein the operation router component is configured for, in response to the intercepting of the file write operation associated with storing the data provided by the write operation, determining whether the data provided by the write operation can be stored according to predefined storage size information included on the removable memory device.

15. The system of claim 13 wherein the removable memory device is operatively coupled to a host device, wherein the host device includes a host device communication system component configured for contacting a server based on information received from the removable memory device to identify a storage location on the server and configured for sending the data provided by the write operation to the server for storage at the identified storage location.

16. The system of claim 13 wherein the removable memory device includes a communication system component configured for contacting a server based on information included on the removable memory device to identify a storage location on the server sending the data provided by the write operation to the server for storage at the identified storage location.

17. The system of claim 13 wherein the removable memory device is operatively coupled to a host device, wherein the descriptor database manager component is configured for sending the identifier to a communication system of the host device, wherein the host device communication system component is configured for retrieving the data associated with the second file from the storage location on the server based on the identifier.

18. The system of claim 13 wherein the removable memory device includes a communication system configured for retrieving the data associated with the second file from the identified storage location on the server.

19. The system of claim 18 wherein the descriptor database manager component is configured for storing a copy of the retrieved data associated with the second file in memory included in the removable memory device, wherein the data associated with the second file can be retrieved from the removable memory device.

20. The system of claim 13 wherein the descriptor database manager component is configured for storing the data provided by the write operation in memory included in the removable memory device and for scheduling the sending of the data provided by the write operation for sending the data via a network to the server at a later time.

21. The system of claim 13 wherein the descriptor database manager component is configured for scheduling the retreival of the data associated with the second file for retreiving the data via a network from the server at a later time.

22. The system of claim 13 wherein the removable memory device is a universal serial bus compatible device.

23. The system of claim 13 wherein the identifier for identifying the storage location includes at least one of a uniform resource identifier and a network address.

24. A computer readable medium including a computer program, executable by a machine, for providing remote storage via a removable memory device, the computer program comprising executable instructions for:
intercepting at least one of a file write operation associated with storing a first file to a removable memory device and a file read operation associated with retrieving a second file from the removable memory device;
in response to the intercepting of the file write operation, contacting a server based on information included on the removable memory device to identify a storage location on the server for storing data provided by the write operation, storing a representation of the first file on the removable memory device including an identifier for identifying the storage location, and providing for sending the data provided by the write operation to the server for storage at the identified storage location; and
in response to the intercepting of the file read operation, extracting an identifier for identifying a storage location on a server from a representation of the second file stored on the removable memory device and providing for retrieving data associated with the second file from the identified storage location on the server.
